(19) United States
(12) Patent Application Publication
(10) Pub. No.: US 2021/0394567 A1
(43) Pub. Date: Dec. 23, 2021

(54) DOUBLE-X-SHAPED TIRE STABILIZER

(71) Applicant: FORCOME (ZHEJIANG) CO., LTD., Jinhua (CN)

(72) Inventors: Xiaojun NI, Jinhua (CN); Chengsheng FANG, Jinhua (CN); Jiancheng WANG, Jinhua (CN)

(21) Appl. No.: 16/941,159

(22) Filed: Jul. 28, 2020

(30) Foreign Application Priority Data
Jun. 19, 2020 (CN) 202010562826.2

(51) Int. Cl. B60C 25/00; B66F 7/06; B66F 7/26; B66F 7/28

(52) U.S. Cl. CPC B60C 25/007; B66F 7/0608; B66F 7/28; B66F 7/26; B66F 7/065

(57) ABSTRACT

A tire stabilizer includes a partially threaded rod, the rod having a smooth end and a threaded end; a first connector rotatably attached to smooth end of the rod; a second connector threadedly attached to the threaded end of the rod; four first supporting members, each first supporting member including a first end and a second end, the first end of the first supporting member being rotatably attached to the first connector; four second supporting members, each second supporting member including a first end and a second end, the first end of the second supporting member being rotatably attached to the second connector; and two first locking pads, each locking pad being rotatably attached to the second ends of two of the four first supporting members; and two second locking pads, each locking pad being rotatably attached to the second ends of two of the four second supporting member.

The present invention claims priority to Chinese Patent Application No. 202010562826.2, filed on Jun. 19, 2020, which is incorporated by reference for all purposes as if fully set forth herein.

### FIELD OF THE INVENTION

The present invention relates to a double-X-shaped tire stabilizer that prevents a parked vehicle from inadvertently rolling.

### BACKGROUND OF THE INVENTION

RVs are divided into two major categories: one with its own power i.e., motorhomes, and the other without its own power system and brake system, i.e., towable RVs. Towable RVs are pulled by a truck or car. When parked, a RV jack is generally used to lift the RV to keep the wheels off the ground to prevent the RV from rolling. For temporary parking, it is not convenient to use the RV jack. There is a need for an improved tire stabilizer that prevents a parked vehicle from inadvertently rolling.

### SUMMARY OF THE INVENTION

In one embodiment, a tire stabilizer includes: a partially threaded rod, the partially thread rod having a smooth end and a threaded end; a first connector rotatably attached to the smooth end of the partially threaded rod; a second connector threadedly attached to the threaded end of the partially threaded rod, the second connector moving axially relative to the partially threaded rod when the partially threaded rod rotates relative to the second connector; four first supporting members, each first supporting member including a first end and a second end, the first end of the each first supporting member being rotatably attached to the first connector; four second supporting members, each second supporting member including a first end and a second end, the first end of the each second supporting member being rotatably attached to the second connector; and two first locking pads, each first locking pad being rotatably attached to the second ends of two of the four first supporting members; and two second locking pads, each second locking pad being rotatably attached to the second ends of two of the four second supporting members. Each two of the four first supporting members and each two of the four second supporting members are rotatably connected at a common center point and form a double-X-shaped supporting frame.

In another embodiment, the tire stabilizer further includes two washers and a pin. The partially threaded rod includes a nut and a pin through hole at the smooth end; the two washers are placed between the nut and the pin through hole; the first connector is located between the two washers; and the pin is inserted into the pin through hole to secure the first connector to the partially threaded rod.

In another embodiment, the tire stabilizer further includes a handle. The handle is attached to the first connector.

In another embodiment, the first locking pads and the second locking pads each include a connecting part, and a locking surface, and the locking surface includes a plurality of anti-slip protrusions.

In another embodiment, the handle includes a hook and a flapper.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a tire stabilizer in an expanded open position.

FIG. 2 shows the tire stabilizer in an open position.

FIG. 3 shows the tire stabilizer in a closed position.

FIG. 4 show the tire stabilizer with a bolt sleeve in an open position.

In the figures, reference numerals are defined as follows: 1. double-X-shaped supporting frames; 3. a first connector; 4. a second connector; 5. a partially threaded rod; 6. a nut; 7A. first locking pads; 7B. second locking pads; 8. a threaded end of the partially threaded rod; 9. a smooth end of the partially threaded rod; 10. a pin through hole; 11. washers; 12. a pin; 13. anti-slip protrusions; 14. connecting parts; 15. a handle; 16. a hook; 17. a flap; 18. locking surfaces; 19. common center points; 21. first supporting members; 21A. first ends of the first supporting members; 21B. second ends of the first supporting members; 22. second supporting members; 22A. first ends of the second supporting members; 22B. second ends of the second supporting members; 31. first bolts; 32. a first bolt hole; 33. second bolts; 34. a second bolt hole; 35. bolt sleeve; and a double-X-shaped tire stabilizer 100.

### DETAILED DESCRIPTION OF THE ILLUSTRATED EMBODIMENTS

Reference will now be made in detail to embodiments of the present invention, example of which is illustrated in the accompanying drawings.

In the description of the present application, it is necessary to understand that the terms “center,” “top,” “bottom,” “left,” “right,” “vertical,” “horizontal,” “inside,” “outside,” “bottom,” “top” and other indicative orientation or position relations are based on the orientation or position relations shown in the drawings. This is intended only for the convenience of describing and simplifying the description of the present application, and is not intended to indicate or imply that the device or element referred to must have a specific orientation, or be constructed and operated in a specific orientation, and therefore cannot be understood as a limitation on the new form of the utility.

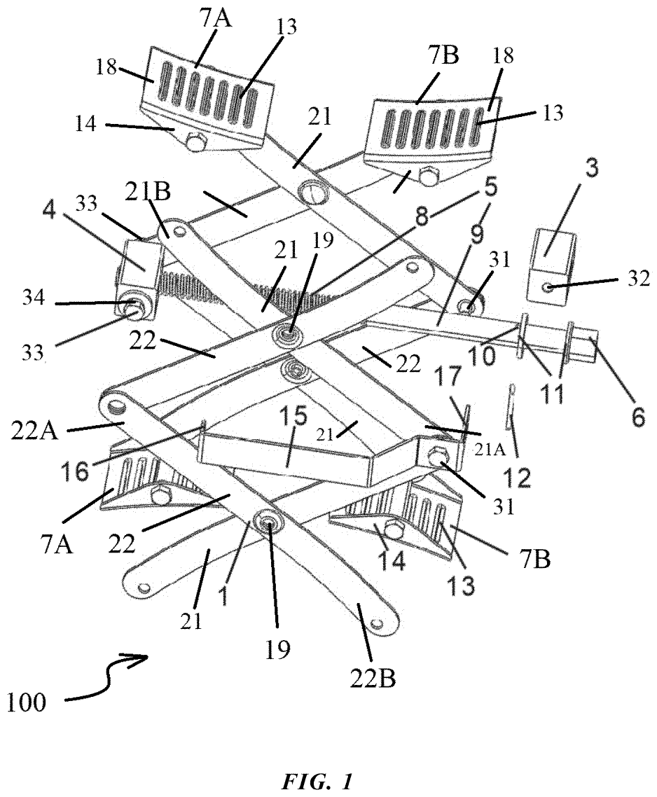

As shown in FIGS. 1, 2, and 3, a double-X-shaped tire stabilizer 100 includes two double-X-shaped supporting frames 1, a first connector 3, a second connector 4, a partially threaded rod 5, two first locking pads 7A, and two second locking pads 7B. Each double-X-shaped supporting frame 1 consists of two first supporting members 21 and two second supporting members 22. The double-X-shaped tire stabilizer includes a total of four first supporting members 21 and four second supporting members 22. Each two of the four first supporting members 21 and each two of the four second supporting members 22 are rotatably connected at a common center point 19 and form a double-X-shaped supporting frame 1.

The first supporting members 21 includes first ends 21A and second ends 21B. The second supporting members 22 include first ends 22A and second ends 22B. The first ends 21A of the first supporting members 21 are rotatably attached to the first connector 3. The first ends 22A of the second supporting members 22 are rotatably attached to the second connector 4.

Each of the two first locking pads 7A is rotatably attached to the two second ends 21B of two of the four first supporting members 21; and each of the two second locking pads 7B is rotatably attached to the two second ends 22B of two of the four second supporting members 22. The first locking pads 7A and the second locking pads 7B can be the same. The first locking pads 7A and the second locking pads 7B each include a locking surface 18 and a connecting part 13. The locking surface 18 includes a plurality of ant-slip protrusions 14.

The partially threaded rod 5 includes a threaded end 8 and a smooth end 9. The first connector 3 is rotatably attached to the smooth end 9 of the partially threaded rod 5. The second connector 4 is threadedly attached to the threaded end 8 of the partially threaded rod 5, and the second connector 4 moves axially relative to the partially threaded rod 5 when the partially threaded rod 5 rotates relative to the second connector 3.

The smooth end 9 of the partially threaded rod 5 includes a nut 6 and a pin through hole 10. The nut 6 is located at the far end of the smooth end 9. The first connector 3 and two washers 11 are placed between the nut 6 and the pin through hole 10. A pin 12 is inserted into the pin through hole 10 to secure the first connector 3 to the partially threaded rod 5. The nut 6 is securely connected to the partially threaded rod 5. When the nut 6 rotates, the partially threaded rod 5 rotates with the nut 6.

The double-X-shaped tire stabilizer 100 also includes a handle 15. The handle 15 includes a hook 16 and a flapper 17. The handle 15 is connected to the first connector 3.

The first connector 3 includes a first bolt hole 32 and two first bolts 31. The first bolts 31 connect the first supporting members 21 and the handle 15 and insert into the first bolt hole 32 to securely attach the first supporting members 21 and the handle 15 to the first connector 3.

The second connector 4 includes a bolt hole 34 and two second bolts. The second blots connect the second supporting members 22 and insert into the second bolt hole 34 to securely attach the second supporting members 22 to the second connector 4.

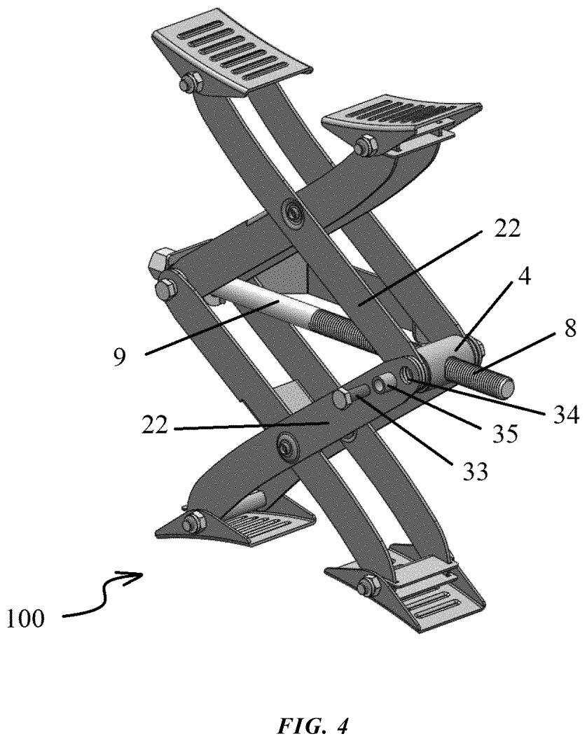

As shown in FIG. 4, the double-X-shaped tire stabilizer 100 can further include a bolt sleeve 35. The second bolts 33 pass through the bolt sleeve 35 and the second supporting members 22 and insert into the second bolt hole 34. The bolt sleeve 34 allows the second bolts 33 to be securely connected to the second connector 4, and also allows the second supporting members 22 to move freely with the second connector 4.

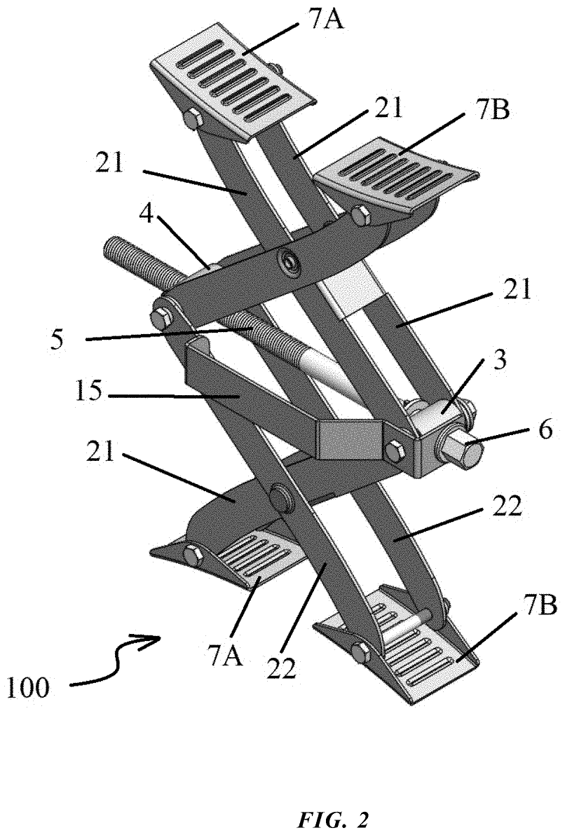

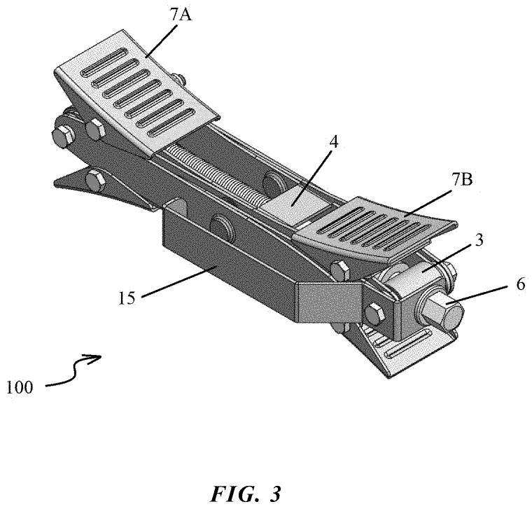

To operate the stabilizer, the double-X-shaped tire stabilizer 100 is placed between two adjacent tires. One will use a tool, e.g., a wrench, to rotate the nut 6. The partially threaded rod 5 rotates with the nut 6, and the second connector 4 moves axially relative to the partially threaded rod 5. Thus, the double-X-shaped tire stabilizer will move from a closed position (FIG. 3) to an open position (FIG. 2). In the open position, the first locking pads 7A and second locking pads 7B contact the surfaces of the adjacent tires. The first locking pads 7A and second locking pads 7B are rotatably attached to the first supporting members 21 and the second supporting member 22, so the locking pads may rotate to an ideal tire contact position to accommodate different tire sizes and shapes.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A tire stabilizer comprising:
a partially threaded rod, the partially thread rod having a smooth end and a threaded end;
a first connector rotatably attached to the smooth end of the partially threaded rod;
a second connector threadedly attached to the threaded end of the partially threaded rod, the second connector moving axially relative to the partially threaded rod when the partially threaded rod rotates relative to the second connector;
four first supporting members, each first supporting member including a first end and a second end, the first end of the each first supporting member being rotatably attached to the first connector;
four second supporting members, each second supporting member including a first end and a second end, the first end of the each second supporting member being rotatably attached to the second connector; and
two first locking pads, each first locking pad being rotatably attached to the second ends of two of the four first supporting members; and
two second locking pads, each second locking pad being rotatably attached to the second ends of two of the four second supporting members,
wherein each two of the four first supporting members and each two of the four second supporting members are rotatably connected at a common center point and form a double-X-shaped supporting frame.

2. The tire stabilizer of claim 1 further comprising:
two washers and a pin,
wherein the partially threaded rod includes a nut and a pin through hole at the smooth end; the two washers are placed between the nut and the pin through hole; the first connector is located between the two washers; and the pin is inserted into the pin through hole to secure the first connector to the partially threaded rod.

3. The tire stabilizer of claim 1 further comprising:
a handle,
wherein the handle is attached to the first connector.

4. The tire stabilizer of claim 1, wherein the first locking pads and the second locking pads each include a connecting part, and a locking surface, and the locking surface includes a plurality of anti-slip protrusions.

5. The tire stabilizer of claim 3, wherein the handle includes a hook and a flapper.
